(19) United States
(12) Patent Application Publication
(10) Pub. No.: US 2008/0272166 A1
(43) Pub. Date: Nov. 6, 2008

(54) Accessory device for automobile

(76) Inventors: David Frank, Hollywood, FL (US); Yael Frank, Hollywood, FL (US)

Correspondence Address: BUCHANAN, INGERSOLL & ROONEY PC, POST OFFICE BOX 1404, ALEXANDRIA, VA, 22313-1404, US

(21) Appl. No.: 11/797,184

(22) Filed: May 1, 2007

(51) Int. Cl. B60N 99/00

(52) U.S. Cl. 224/544

(57) ABSTRACT

An accessory device for use in an automobile includes a body member, and a peripheral flange surrounding the body member. The body member is formed of an elastomeric material such that it is conformable to a gap within the automobile for catching falling objects and/or storing miscellaneous objects. The peripheral flange is also preferably formed of an elastomeric material. The body member defines an open receptacle having an opening on an uppermost surface of the accessory device, thereby providing access for objects to be placed within the receptacle.

### TECHNICAL FIELD

The present invention is directed to an accessory device adapted to be disposed within a gap in an automobile, and more particularly, to be fitted between the front seats and console in an automobile interior, thereby preventing small objects from falling into the gap and becoming difficult to retrieve.

### BACKGROUND

In automobiles having two front seats with a console therebetween, there is a gap between the seats and the console into which small objects, such as coins, pens, papers, and the like, are continually falling. After falling into this gap, the objects are difficult to retrieve from the lower flooring of the automobile, particularly when the automobile is in motion.

Addressing this same problem, U.S. Pat. No. 4,948,195 discloses a wedge constructed from cardboard having two vertical side members with the top closed by an accordion pleated section. The pleated top permits adjusting the width of the wedge near the top inside surface to accommodate various spacings between the seat and the console. The wedge is maintained in the expanded configuration by strips of compressible elastomer material. The compressible elastomer material is supplied in a plurality of spaced blocks having adhesive surfaces covered with a peel-off protective sheet on each end near the top of the inside surface, to permit tailoring the wedge width to a particular automobile.

In order to avoid objects from falling into a similar gap, U.S. Pat. No. 2,571,574 to Hicks discloses an attachment for covering the gap between adjoining rear portions of the seat cushions of automobile seats of the type having respective pivoted seat backs adapted to be swung forward.

Neither of these devices provides a satisfactory solution to the problem at hand. Accordingly, there exists a need for a device to prevent objects from falling into cracks, which is both simple to install and adaptable to the wide variety of crevices existing in today's automobiles.

### SUMMARY

These and other objects of the invention are provided by an accessory device including a body member and an outer flange. The body member is preferably configured as a receptacle opening to catch objects which may inadvertently fall within a gap in an automobile, or for the placement of objects therein by the user. The body member is preferably formed of a gel-type, elastomeric material and is configured to be inserted into the gap in the automobile, such as the gap occurring between a front seat and a center console, a front seat and an automobile door, between two back seats, or the like. Due to the compressible nature of the body member, it is easily conformable and adaptable to the various different shapes of gaps which occur given the different manufacturers of automobiles. The outer flange is also preferably formed of a pliable, elastomeric material and assists in sealing the upper edge of the accessory device within the gap.

### BRIEF DESCRIPTION OF THE DRAWING FIGURES

These and other objects, features, and advantages of the present invention will become more readily apparent to those skilled in the art upon reading the following detailed description, in conjunction with the appended drawings in which:

FIG. 1 is a top perspective view of an accessory device for automobile interior according to a preferred embodiment of the invention.

FIG. 2 is a top plan view thereof.

FIG. 3 is a side elevational view thereof.

FIG. 4 is an end elevational view thereof.

FIG. 5 is a schematic illustration of the accessory device disposed between the console of an automobile and each of the front seats.

### DETAILED DESCRIPTION OF THE PREFERRED EMBODIMENT

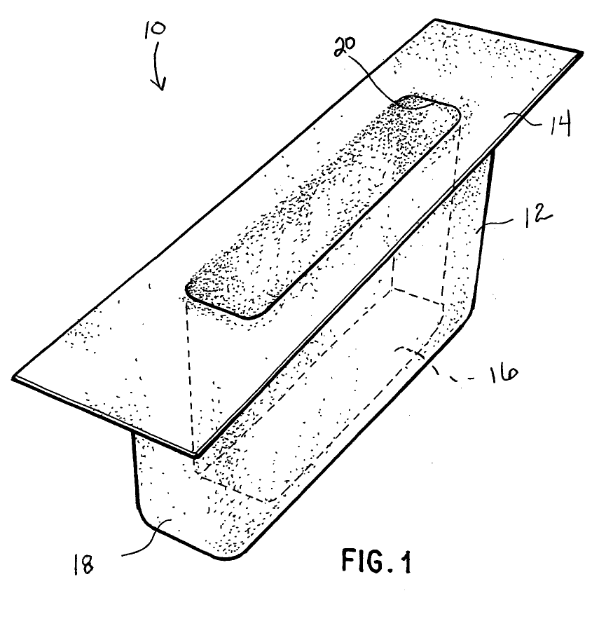

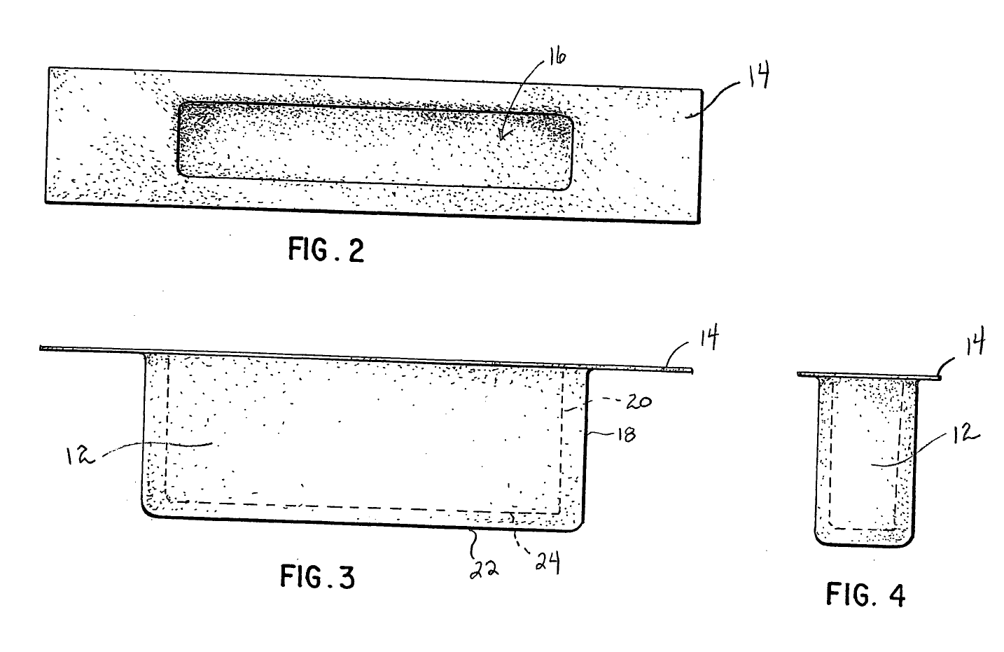

Referring to FIGS. 1-4, an accessory device for use within the interior of an automobile is shown generally by reference numeral 10. Accessory device 10 includes a body member 12 and an outer flange 14. The body member 12 is preferably configured as a receptacle opening 16 to catch objects which may inadvertently fall within a gap in an automobile, or for the placement of objects therein by the user. Thus, the body member includes an outer wall perimeter 18, an inner wall perimeter 20 defining the wall surface of the opening 16, an outer bottom surface 22 and an inner bottom surface 24 defining the bottom of the opening 16. The dimensions of the accessory device 10 and, more particularly, the receptacle opening 16 therein, can be chosen to meet a given user demand. That is, large trucks may require a larger accessory device than a small sports car, and a larger receptacle opening 16 may be preferred because of the larger overall size. The depth of the receptacle opening 16 may also vary depending upon user preference. In a preferred embodiment of the invention, body member 12 has an overall length of approximately 59 cm-62 cm and an overall transverse width of approximately 2 cm-6 cm and the receptacle opening 16 formed therein has a length of approximately 30 cm-50 cm and a width of approximately 1.8 cm-5 cm. More preferably, body member 12 has an overall length of approximately 61 cm and an overall transverse width of approximately 2.5 cm and the receptacle opening 16 formed therein has a length of approximately 40 cm. and a width of approximately 3 cm. The receptacle opening 16 has a preferred depth of between approximately 20 and 26 cm, thereby providing structural integrity to the body member 12 yet still allowing adequate area for catching falling objects and/or storing miscellaneous objects in a nearby and easily accessible location. As will be appreciated by one skilled in the art, rather than including a receptacle 16, the body member 12 may merely have a planar upper surface which would also serve the purpose of preventing objects from falling within a gap between seats or the like.

The body member 12 is formed of a gel-type, elastomeric material and is configured to be inserted into a gap in the automobile, such as the gap occurring between a front seat and a center console, a front seat and an automobile door, between two back seats, or the like. Due to the compressible nature of the body member 12, it is easily conformable and adaptable to the various different shapes of gaps which occur given the different manufacturers of automobiles.

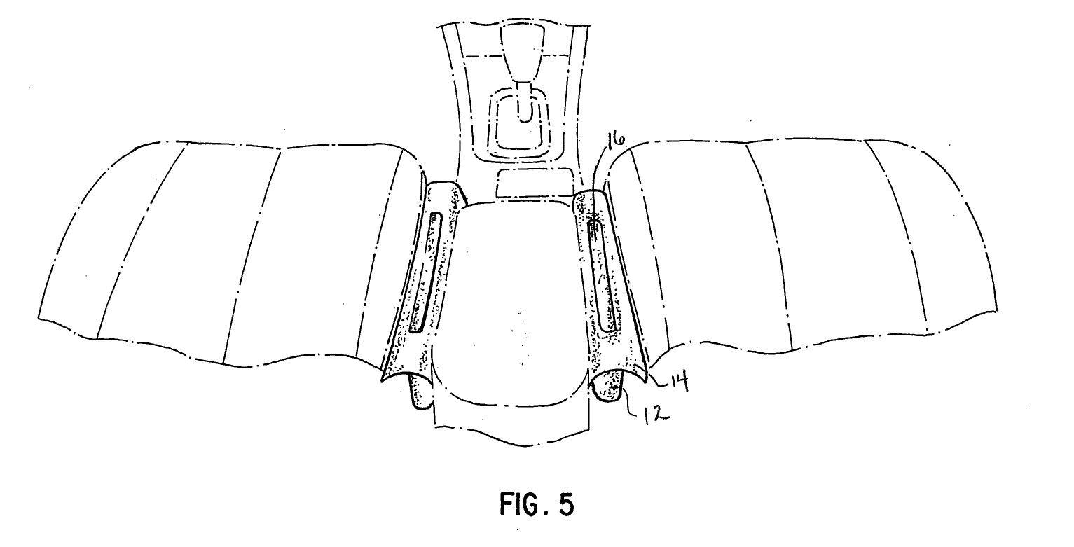

The outer flange 14 is formed of a pliable, elastomeric material and assists in sealing the upper edge of the device 10 within a gap, as shown best in FIG. 5. The outer flange 14 extends outwardly from the body member 12 along each of the longitudinal and transverse sides thereof, having a preferred width along the longitudinal sides of approximately 3.75 cm and a preferred width along the transverse sides of approximately 3.75 cm. The outer flange 14 has a preferred thickness of approximately 0.625 cm, thereby providing the flange with sufficient structural integrity to resist tearing yet still allowing considerable manipulation and flexing of the flange 14 in order to obtain proper arrangement of the accessory device 10 within a gap.

While the present invention has been described with respect to the preferred embodiments thereof, this is by way of illustration for purposes of disclosure rather than to confine the invention to any specific arrangement as there are various alterations, changes, deviations, eliminations, substitutions, omissions and departures which may be made in the particular embodiment shown and described without departing from the scope of the claims.

What is claimed is:

1. An accessory device for use in an automobile, said device comprising:
a body member, and
a peripheral flange surrounding said body member,
wherein said body member is formed of an elastomeric material such that it is conformable to a gap within the automobile.

2. The accessory device of claim 1, wherein said peripheral flange is formed of an elastomeric material.

3. The accessory device of claim 1, wherein said body member defines an open receptacle.

4. The accessory device of claim 3, wherein said receptacle includes an opening on an uppermost surface of the accessory device, thereby providing access for objects to be placed within said receptacle.

5. The accessory device of claim 1, wherein said body member has an overall length between approximately 59 cm and 62 cm.

6. The accessory device of claim 5, wherein said body member has an overall transverse width between approximately 2 cm and 6 cm.

7. The accessory device of claim 3, wherein said open receptacle has a depth between approximately 20 cm and 26 cm.
